(19) United States
(12) Patent Application Publication
(10) Pub. No.: US 2008/0022136 A1
(43) Pub. Date: Jan. 24, 2008

(54) Encryption load balancing and distributed policy enforcement

(75) Inventors: Ulf Mattsson, Stamford, CT (US); Yigal Rozenberg, Rehovot (IL)

Correspondence Address: EDWARDS ANGELL PALMER & DODGE LLP, P.O. BOX 55874, BOSTON, MA, 02205, US

(73) Assignee: Protegrity Corporation, Grand Cayman (KY)

(21) Appl. No.: 11/644,106

(22) Filed: Dec. 21, 2006

Related U.S. Application Data
(63) Continuation-in-part of application No. 11/357,926, filed on Feb. 17, 2006.
(63) Continuation-in-part of application No. 11/357,351, filed on Feb. 17, 2006.
(60) Provisional application No. 60/654,367, filed on Feb. 18, 2005.
(60) Provisional application No. 60/654,129, filed on Feb. 18, 2005.
(60) Provisional application No. 60/654,614, filed on Feb. 18, 2005.
(60) Provisional application No. 60/654,145, filed on Feb. 18, 2005.

(51) Int. Cl. G06F 11/30

(52) U.S. Cl. 713/194

(57) ABSTRACT

To achieve encryption load balancing, a dispatcher, in communication with one or more engines, delegates one or more requests to the one or more engines. The engines execute cryptographic operations on data. The dispatcher may implement one or more load balancing algorithms to delegate requests to engines in accordance with data protection classes and rules for improved efficiency, performance, and security. To achieve distributed policy enforcement, the engines may also analyze whether the request violates an item access rule.

### CROSS-REFERENCE TO RELATED APPLICATIONS

This is a continuation-in-part of U.S. patent application Ser. No. 11/357,926, filed Feb. 17, 2006, which claims priority both to provisional U.S. patent application Ser. No. 60/654,367, filed Feb. 18, 2005, and to provisional U.S. patent application Ser. No. 60/654,129, filed Feb. 18, 2005; and of U.S. patent application Ser. No. 11/357,351, filed Feb. 17, 2006, which claims priority both to provisional U.S. patent application Ser. No. 60/654,614, filed Feb. 18, 2005, and to provisional U.S. patent application Ser. No. 60/654,145, filed Feb. 18, 2005. The entire contents of each of these six applications is incorporated by reference herein.

### TECHNICAL FIELD

The present invention generally relates to improving the performance when encrypting or de-encrypting all or a portion of a database, a file system, or some other data at rest system with an encryption key and improving the performance of policy enforcement systems.

### BACKGROUND INVENTION

When using encryption in a data storage environment, the actual cryptographic operations can be accomplished in different locations on the storage device side or on the application side. When the storage device, e.g., a DBMS (database management system) or a file server, encrypts data, many applications are unaffected by the encryption. Thus, storage device-based encryption can be implemented without making major changes in legacy applications. However, this also means that unless additional measures are taken, any data that enters or leaves the storage device will be decrypted, and will therefore be transported as clear text.

A further vulnerability of DBMS-based encryption is that the encryption key used to encrypt data is often stored in a database table inside the database, protected by native DBMS access controls. Frequently, the users who have access rights to the encrypted data also have access rights to the encryption key. This can create a security vulnerability because the encrypted text is not separated from the key used to decrypt it.

Another drawback of storage device based encryption is that a limited number of servers bear the processing load on behalf of a potentially unlimited number of applications. Because encryption and decryption are performed within the storage device, the storage device is asked to perform additional processing, not only when the data is stored, but each time the data is accessed.

Moving the encryption to the applications that generate the data improves security. However, this may require source code level changes to the applications to enable them to handle the cryptographic operations. In addition, having applications carry out encryption may also prevent data sharing between applications. Critical data may no longer be shared between different applications, even if the applications are re-written. Thus, moving encryption to the application may be unsuitable for large scale implementation, may create more communication overhead, and may require more server administration.

Moreover, encryption alone may not be sufficient to protect sensitive data. In addition to encryption, monitoring systems are sometimes employed to monitor access to data. However, a monitoring system, particularly a monitoring system that observes all data in an enterprise may hinder performance. For example, the device may function as a “choke point” if all data, requests and other network traffic must flow through the device.

### SUMMARY OF THE INVENTION

The invention generally relates to implementing database encryption and/or policy enforcement at a layer between a device and an application. Such an implementation has various advantages such as, for example, minimizing the exposure of clear text, separating responsibilities for storage device management and encryption, allowing for greater scalability of encrypted storage devices, and promoting greater security by separating security management from storage device management. In connection with certain embodiments of the inventions, a database manager may deal with an encrypted database to perform routine maintenance, but the database manager would not be provided with access to any encryption keys. The advantages of such an arrangement become especially salient when database management is outsourced to another company, possibly in another country.

Moreover, by implementing policy enforcement between the device and the application, policy enforcement may remain within the owner's control by obviating the need to rely on the device and the potentially untrusted third party who may manage the device. Policy enforcement at this intermediate layer also allows for a loosely coupled policy enforcement system that may be implemented without the need for extensive modifications in the application or device layers. Finally, a loosely coupled solution allows for high scalability and redundancy through the addition of multiple engines to analyze data requests, thereby alleviating any potential performance problems.

In one aspect, the invention generally relates to an encryption load balancing and distributed policy enforcement system that comprises one or more engines and a dispatcher. The engines are for communicating with one or more devices and executing cryptographic operations on data. The dispatcher is in communication with one or more engines and receives one or more requests from a client and delegates at least one of the one or more requests to the one or more engines.

Embodiments according to this aspect of the invention can include various features. For example, the data may be contained in or produced in response to the one or more requests. In another example, a first of the engines may have a different service class than a second of the engines. In another example, the device is a database and the requests are queries. The dispatcher may be configured to parse at least one of said one or more queries and delegate at least one of the one or more queries to a subset of said one or more engines on the basis of query type. The dispatcher may be configured to delegate at least one of the one more queries to the client. Additionally or alternatively, the client may be configured to delegate at least one of the one more queries to the client. The addition of an additional engine may require minimal manual configuration.

The dispatcher may be configured to delegate at least one of the one or more queries to at least one of the one or more engines using a load balancing algorithm. The load balancing algorithm may be a shortest queue algorithm wherein a length of at least one of the one or more engines' queue is weighted. In a further example, the queue is weighted to reflect complexity of at least one of the one or more requests delegated to the engine. The queue may also or alternatively be weighted to reflect the engine's processing power.

The dispatcher may be in further communication with a key management system to obtain one or more encryption keys related to the one or more queries. One or more encryption keys communicated by the dispatcher to the one or more engines may be encrypted with a server encryption key.

One or more of the engines may be configured to analyze whether one of the requests violates an item access rule. The system may also contain an access control manager for distributing one or more access rules to at least one of the one or more engines. At least one of the engines may report an item access rule violation to the access control manager. The access control manager may analyze the violation and adjust at least one item access rule for a user or a group.

In another aspect, the invention involves an encryption load balancing system that comprises one or more devices, a client, a key management system, one or more engines, and a dispatcher. The client can have an application for generating one or more requests for data residing on the devices. The key management system is in communication with a policy database. The engines are in communication with the one or more devices and are for executing cryptographic operations on data contained in or produced in response to the one or more requests. The dispatcher is in communication with the client, the key management system and the one or more engines. The dispatcher receives the requests from the client, communicates with the key management system to verify the authenticity and authorization of the requests, and delegates the requests to the one or more engines using a load balancing algorithm.

In yet another aspect, the invention generally relates to an encryption load balancing method that comprises receiving a request for information residing on a device from a client and delegating the request to one or more engines configured to execute cryptographic operations on data.

Embodiments according to the invention can include various features. For example, the method can further comprise dividing the request into one or more sub-requests. The method can further comprise delegating at least one of the sub-requests to the client. The request can be delegated using a load balancing algorithm. The method may further comprise communicating with a key management system to determine whether a request is authorized. The method may also include communicating with a key management system to determine the key class of a request. In another example, the request is a sub-request. The request or sub-request may be an insertion command.

The method can further comprise generating encrypted data from the data in the request, amending the request to replace the data with the encrypted data, and forwarding the request to the device. Further, the method may comprise determining whether the request constitutes a violation of at least one item access rule and notifying an access control system of the violation. Alternatively or in combination, the method may further comprise forwarding the request to the device, receiving encrypted data from the device, decrypting the encrypted data, and returning unencrypted data to a client. The method may further comprise determining whether the result of the request constitutes a violation of at least one item access rule and notifying the access control system of the violation.

In another aspect, the invention involves an encryption load balancing method that comprises receiving a request for information residing on a device from a client, verifying authorization of the request and determining a key class of the request by communicating with a key management system, and delegating, through use of a load balancing algorithm, the request to one or more engines configured to execute cryptographic operations on data. The engine generates encrypted data from the data in the request, amends the request to replace the data with the encrypted data, and forwards the request to the device.

In yet another aspect, the invention involves an encryption load balancing method that comprises receiving a request for information residing on a device from a client, verifying authorization of the request and determining a key class of the request by communicating with a key management system, and delegating, through use of a load balancing algorithm, the request to one or more engines configured to execute cryptographic operations on data. The engine forwards the request to the device, receives encrypted data from the device, decrypts the encrypted data, and returns unencrypted data to the client.

In another aspect, the invention is directed to a computer-readable medium whose contents cause a computer to perform an encryption load balancing method that comprises receiving a request for information residing on a device from a client, and delegating the request to one or more engines configured to execute cryptographic operations on data.

In another aspect, the invention is directed to an encryption load balancing system that comprises a first preprocessor, a second preprocessor, and a dispatcher. The first preprocessor is for communicating with one or more storage devices and for receiving requests from a client application. The second preprocessor is for executing cryptographic operations on data contained in or produced in response to the requests. The dispatcher is arranged to divide a request into at least a first and a second sub-request, and to delegate the first sub-request to the first preprocessor and the second sub-request to the second preprocessor. The sub-requests can be delegated to the preprocessors using a load balancing algorithm.

In yet another aspect, the invention is directed to an encryption load balancing system that comprises one or more storage devices, a first preprocessor, a second preprocessor, the second preprocessor, and a dispatcher. The storage devices have a first portion encrypted at a first encryption level and a second portion encrypted at a second encryption level that differs from the first encryption level. The first preprocessor is configured to receive a request for information residing on one or more of the storage devices from a client application. The request includes seeking interaction with first data from the first portion and seeking interaction with second data from the second portion. The second preprocessor is in communication with the first preprocessor and is configured to execute a cryptographic operations on data contained in and produced in response to the request. The dispatcher is in communication with the first preprocessor. The dispatcher is configured to separate a database request into a first sub-request for interaction with the first data and a second sub-request for interaction with the second data, to delegate the first sub-request to the first preprocessor, and to delegate the second sub-request to the second preprocessor. The dispatcher can delegate a plurality of sub-requests to a plurality of second preprocessors using a load balancing algorithm.

### BRIEF DESCRIPTION OF THE DRAWINGS

The drawings generally are to illustrate principles of the invention and/or to show certain embodiments according to the invention. The drawings are not to scale. Like reference symbols in the various drawings generally indicate like elements. Each drawing is briefly described below.

FIG. 1a is a schematic block diagram of a database system including a preprocessor in accordance with the subject technology.

FIG. 1b is a schematic block diagrams of another database system including a preprocessor in accordance with the subject technology.

FIGS. 2a and 2b are flowcharts of methods suitable for implementation by the systems in FIGS. 1a and 1b, respectively, in accordance with the subject technology.

FIGS. 3a, 3b, and 3c are schematic block diagrams of database systems in which a dispatcher assigns queries and subqueries to one or more engines in accordance with the subject technology.

FIGS. 4 and 5 are flowcharts of a method suitable for implementation by the systems in FIGS. 3a, 3b, and 3c in accordance with the subject technology.

FIGS. 6a, 6b, and 6c are schematic diagrams depicting a delegation of requests in the systems in FIGS. 3a, 3b, and 3c in accordance with the subject technology.

FIG. 7 is a schematic diagram depicting how the attributes of a protected data element affect cryptographic operations in accordance with the subject technology.

### DESCRIPTION

In brief overview, the invention generally relates to implementing database encryption and/or policy enforcement at a layer between a device and an application. The following description is provided to illustrate various embodiments of the invention, but the description is not intended to limit the scope of the invention.

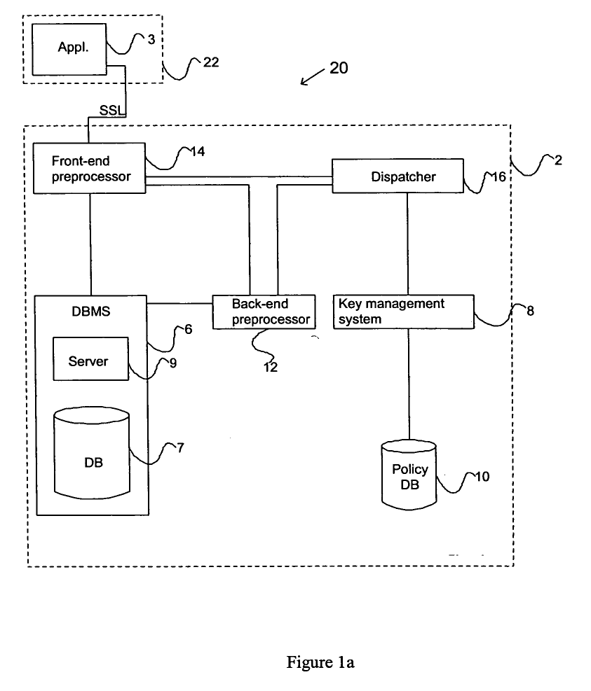

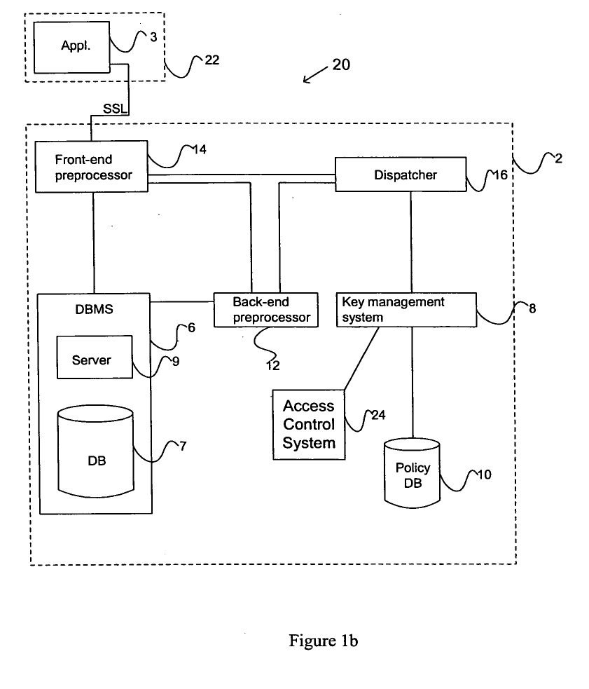

FIG. 1a shows a database system 20 having a client 22 connected to a server platform 2. A client application 3 exists on a client 22, while the server platform 2 includes a DBMS 6 including a database server module 9 (e.g., a Secure.Data™ and/or a DEFIANCE™ DPS, available from Protegrity Corp. of Stamford, Conn.), and a database 7.

Although one client 22 and one server platform 2 are shown, a plurality of each would typically be used in the database system 20. Implementations containing the DBMS 6 are used as exemplary embodiments of the inventions herein and are not intended to be limiting. The inventions described herein are compatible with any type of data at rest system including, but not limited to databases including relational databases and object oriented databases and file systems.

The client 22 can be a desktop computer, laptop computer, personal digital assistant, cellular telephone and the like now known and later developed. The client 22 can have displays. The display may be any of a number of known devices for displaying images responsive to outputs signals from the client 22. Such devices include, but are not limited to, cathode ray tubes (CRTs), liquid crystal displays (LCDs), plasma screens and the like. Although a simplified diagram is illustrated in FIG. 1a such illustration shall not be construed as limiting the present invention to the illustrated embodiment. It should be recognized that the signals being output from the computer can originate from any of a number of devices including PCI or AGP video boards or cards mounted within the housing of the client 22 that are operably coupled to the microprocessors and the displays thereof.

The client 22 typically includes a central processing unit (not shown) including one or more micro-processors such as those manufactured by Intel or AMD, random access memory (RAM), mechanisms and structures for performing I/O operations (not shown), a storage medium such as a magnetic hard disk drive(s), a device for reading from and/or writing to removable computer readable media and an operating system for execution on the central processing unit. According to one embodiment, the hard disk drive of the client 22 is for purposes of booting and storing the operating system, other applications or systems that are to be executed on the computer, paging and swapping between the hard disk and the RAM and the like. In one embodiment, the application programs reside on the hard disk drive for performing the functions in accordance with the transcription system. In another embodiment, the hard disk drive simply has a browser for accessing an application hosted within a distributed computing network. The client 22 can also utilize a removable computer readable medium such as a CD or DVD type of media or flash memory that is inserted therein for reading and/or writing to the removable computer readable media.

The server platform 2 can be implemented on one or more servers that are intended to be operably connected to a network so as to operably link to a plurality of clients 22 via a distributed computer network. As illustration, the server typically includes a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drives of the server may be used for storing data, client applications and the like utilized by client applications. The hard disk drives of the server also are typically provided for purposes of booting and storing the operating system, other applications or systems that are to be executed on the server, paging and swapping between the hard disk and the RAM.

A client 22 is commonly a personal computer. A server is commonly more powerful than a personal computer, but may be a personal computer. It is envisioned that the server platform 2 can utilize multiple servers in cooperation to facilitate greater performance and stability of the subject invention by distributing memory and processing as is well known.

It is envisioned that, in accordance with the client-server model, a client 22 may implement systems and methods associated with the server platform 2 and a server may implement systems associated with the client 22. For example, an application implemented on a server may act as a client 22 with respect to one or more servers implementing the server platform 2. See, e.g., Andrew S. Tanenbaum & Maarten van Steen, Distributed Systems 42-53 (2002).

The servers and clients 22 typically include an operating system to manage devices such as disks, memory and I/O operations and to provide programs with a simpler interface to the hardware. Operating systems include: Unix®, available from the X/Open Company of Berkshire, United Kingdom; FreeBSD, available from the FreeBSD Foundation of Boulder, Colo.: Linux®, available from a variety of sources; GNU/Linux, available from a variety of sources; POSIX®, available from IEEE of Piscataway, N.J.; OS/2®, available from IBM Corporation of Armonk, N.Y.; Mac OS®, Mac OS X®, Mac OS X Server®, all available from Apple Computer, Inc. of Cupertino, Calif.; MS-DOS®, Windows®, Windows 3.1®, Windows 95®, Windows 2000®, Windows NT®, Windows XP®, Windows Server 2003®, Windows Vista®, all available from the Microsoft Corp. of Redmond, Wash.; and Solaris®, available from Sun Microsystems, Inc. of Santa Clara, Calif. See generally Andrew S. Tanenbaum, Modem Operating Systems (2d ed. 2001). Operating systems are well-known and thus not further described herein.

The server platform 2 also includes a key management system 8. A suitable key management system 8 includes a security system (SS) (e.g., Secure.Data Server™ available from Protegrity Corp. of Stamford, Conn.), a security administration system (SAS) (e.g., Secure.Data Manager™ available from Protegrity Corp. of Stamford, Conn.) and a data security extension (DSE), (e.g., Secure.Data™ available from Protegrity Corp. of Stamford, Conn.). The SAS is used by the administrator to manage a policy database 10, which is accessible through the key management system 8 to determine what actions (e.g., reads or writes to specific tables of the database 7) an individual user of client application 3 is permitted to carry out.

The database system further includes a back-end preprocessor 12 adapted to receive queries from the application 3. A front-end preprocessor 14 is in communication with the DBMS 6, and arranged to access information in the database 7. If the database 7 is encrypted, the back-end preprocessor 12 is arranged to handle cryptographic operations.

As noted above, between the application 3 and the DBMS 6 is a front-end preprocessor 14 arranged to intercept any query sent from the application 3 to the back-end preprocessor 12. Preferably, the front-end preprocessor 14 is arranged to recognize a subset of the query language used, e.g., Structured Query Language (SQL). This recognized subset can include simple queries like: “select age from person” and “insert into person values (‘john’, ‘smith’, 34).” The front-end preprocessor 14 can further be arranged to handle cryptographic operations, thus providing an alternative way to enable encryption of the database information.

Connected to both preprocessors 12, 14 and to the key management system 8 is a dispatcher 16 arranged to receive any query intercepted by the front-end preprocessor 14 and to select, based on information in the policy database 10, which preprocessor 12, 14 to use to handle communication with the database 7. In making this selection, the dispatcher also determines which preprocessor 12, 14 will handle cryptographic operations.

The front-end preprocessor 14 can be implemented as a separate process, or can be implemented as an intermediate server, between the client 22 and the server platform 2, e.g., as a proxy server. The components of the server platform 2 may be integrated into one hardware unit, or distributed among several hardware units.

One or more of the preprocessors 12, 14 may be configured enforce one or more policies. Policies contain one or more item access rules to regulate access to data and/or other system resources. A rule may apply generally to all users, or the rule may apply to specific users, groups, roles, locations, machines, processes, threads and/or applications. For example, system administrators may be able to access particular tables and run certain stored procedures that general users cannot. Similarly, some employees may be completely prohibited from accessing one or more databases 7 or may have access to certain databases 7, but not certain tables or columns. Additional examples of item access rules are described in U.S. patent application Ser. No. 11/540,467, filed on Sep. 29, 2006, the contents of which are hereby incorporated by reference herein.

Referring now to FIG. 1b, a database system 30 comprising a client 22 and a server platform 2 is shown. As will be appreciated by those of skill in the art, the system 30 utilizes similar components and principles to the system 20 described above. Accordingly, like reference numerals are used to indicate like elements whenever possible. The primary difference of the system 30 in comparison to system 20 is the addition of an access control system 24 in communication with the key management system. Through the dispatcher 16, the access control system 24 communicates policies to the front-end preprocessor 14 and/or the back-end preprocessor 12. This implementation “pushes” data monitoring and policy enforcement responsibilities to the preprocessors 12, 14, resulting in a distributed security system with improved scalability and performance.

The access control system 24 may be any system or apparatus capable of producing an intrusion detection profile. The access control system 24 may be implemented in many ways including, but not limited to, embodiment in a server, a client, a database or as a freestanding network component (e.g., as a hardware device). In some embodiments, the access control system 24 is part of the DEFIANCE™ suite or the Secure.Data™ server, both available from Protegrity Corp. of Stamford, Conn. The access control system 24 distributes item access rules and/or intrusion detection profiles (which contain item access rules). The access control system 24 continually monitors user activity, and prevents a user from accessing data that the user is not cleared for. This process is described in detail in publication number U.S. Pat. No. 6,321,201, filed Feb. 23, 1998, the contents of which are hereby incorporated by reference.

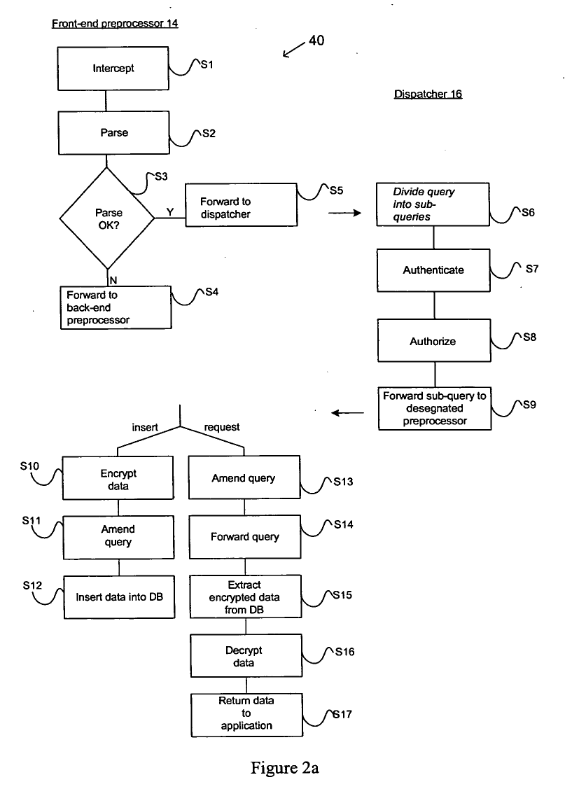

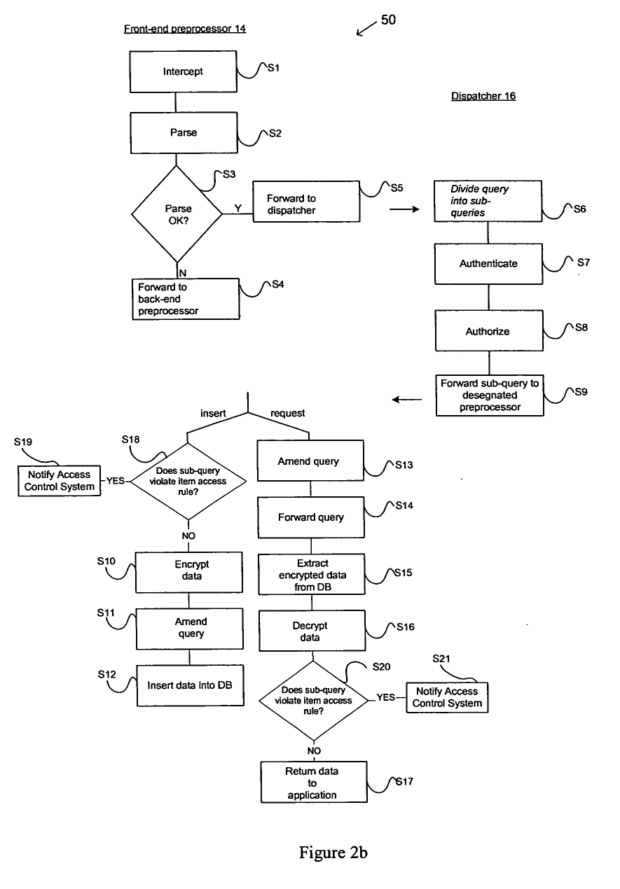

Referring now to FIG. 2a, a flow chart 40 is shown. The front-end preprocessor 14 intercepts a query (step S1) sent to the database 7 from the client 22 and/or the application 3, and attempts to parse this query (step S2). Instead of, or in addition to the query, the front-end preprocessor 14 can receive requests or commands such as a request to create a log entry for an event. If parsing is successful (step S3), the query is forwarded to the dispatcher 16 (step S5). In the illustrated example, with only two preprocessors 12, 14, unrecognized queries are forwarded to the back-end preprocessor 12 (step S4) to be handled in the normal way. In a general case, with a plurality of preprocessors, the dispatcher 16 decides where to send an unrecognized query based on an algorithm or predetermined setting.

Upon receiving the query, the dispatcher 16 divides the query into sub-queries that relate to different portions of the database (step S6). These portions can include selected rows, selected columns, or combinations thereof. These different portions of the database 7 typically have different levels of security and/or encryption.

The dispatcher 16 then authenticates and authorizes the client application 3 (steps S7 and S8), typically by accessing the key management system 8. After authentication and authorization, the dispatcher 16 forwards each sub-query to whichever preprocessor 12, 14 is designated by the key management system 8 to handle encryption of the particular portion of the database 7 associated with that sub-query (step S9).

Sub-queries that are sent to the back-end preprocessor 12 are handled with any encryption that is implemented in the DBMS 6. However, sub-queries that are sent to the front-end preprocessor 14 are handled with additional encryption, thus enabling different types of encryption for different portions of the database 7.

For example, in an insert operation, the front-end preprocessor 14 encrypts the data in the query (step S10), amends the query to replace the data with the encrypted data (step S11), and then forwards the query to the DBMS 6 for insertion into the database 7 (step S12).

In case of a request operation, the front-end preprocessor 14 amends the query (step S13), and forwards the amended query to the DBMS 6 (step S14). The requested information is extracted from the database 7 (step S15) and decrypted (step S16). The decrypted result is then returned to the client application 3 (step S17).

As an example, if the query “select age from person” is recognized and determined by the dispatcher 16 to involve an encrypted table, the query can be amended to “select age from person-enc,” to indicate that data is to be selected from an encrypted portion of the database. When the encrypted data is received from the database 7, the front-end preprocessor 14 decrypts the data before sending the data to the client application 3.

In the same way, “insert into person ‘john’ ‘Smith’, 34” can be amended to “insert into person-enc ‘john’, ‘smith ’, 34” to indicate that the data is to be inserted into an encrypted portion of the database. At the same time, the front-end preprocessor 14 encrypts the data fields in the query, so that the forwarded query will look like “insert into person-enc xxxxx xxxxx xx”. This query ensures that encrypted data is inserted into the database, without requiring any encryption by the DBMS 6.

As is clear from the above, the front-end preprocessor 14 handles cryptographic activity relating to selected portions of the database. Therefore, it should be noted that in a case in which the database 7 is not itself adapted to handle encryption, the server platform 2 can independently create an encrypted interface to the database 7, allowing for cryptography of selected portions of the database. The particular portions of the database to be encrypted are governed by the policy database 10.

In some embodiments, the front-end preprocessor 14 is an add-on to an existing database system. The front-end preprocessor 14 need not be configured to handle SQL syntax errors, as any unrecognized queries (including incorrect queries) are simply forwarded to the DBMS 6 (step S4 in FIG. 2a). However, in other embodiments, the front-end preprocessor 14 is configured to interpret the entire SQL language. This allows the front-end preprocessor 14 to select tables in the policy database 10 and to determine what tables are subject to cryptographic operations.

The front-end preprocessor 14 can support secure socket layer (SSL) with strong authentication to enable an SSL channel between client and server. To provide strong authentication, a certificate used for authentication can be matched to the client application 3 by the database 7 accessed. In the case where the front-end preprocessor 14 is integrated into the DBMS 6, the DBMS 6 will thus have full control of the authentication process. However, it is also possible to implement the DBMS 6 and the preprocessor 14 separately, for example, by implementing the preprocessor 14 as an intermediate server.

Now referring to FIG. 2b, a flow chart 50 is shown. As will be appreciated by those of skill in the art, the flow chart 50 includes similar steps and principles to the flowchart 40 described above. Accordingly, like reference numerals are used to indicate like steps whenever possible. The primary difference of the flowchart 50 in comparison to flowchart 40 is the addition of steps S18-S21 to determine if a sub-query violates an item access rule.

Steps S1-S9 of FIG. 2b are the same as steps S1-S9 described above with respect to FIG. 2a and, for brevity, such discussion is not repeated. When a sub-query is forwarded to a designated pre-processor 12, 14 (step S9), the sub-query may be processed as an insert or a request. For an insert sub-query, the sub-query is analyzed to determine if the sub-query violated an item access rule (e.g., by altering data that the user is not authorized to alter) (step S18). If the sub-query does violate an item access rule, the access control system 24 and/or an alarm system is notified (step 19). If the sub-query does not violate an item access rule, the data is encrypted (S10) and process continues as in flow chart 40 of FIG. 2a.

For a request sub-query, after the data is extracted (step S15) and de-encrypted (step S16), the data is analyzed to determine if the sub-query violated an item access rule (e.g., receiving a large set of credit card numbers) (step S20). If an item access rule is violated, the access control system 24 and/or an alarm system is notified (step S21). If an item access rule is not violated, the data is returned to the application 3 (step S17). In some embodiments, steps S20 and S21 may be additionally or alternatively performed earlier in the process for a request sub-query. For example without limitation, steps S20 and S21 may occur between steps S9 and S13, between steps S13 and S14, and/or between steps S15 and S16.

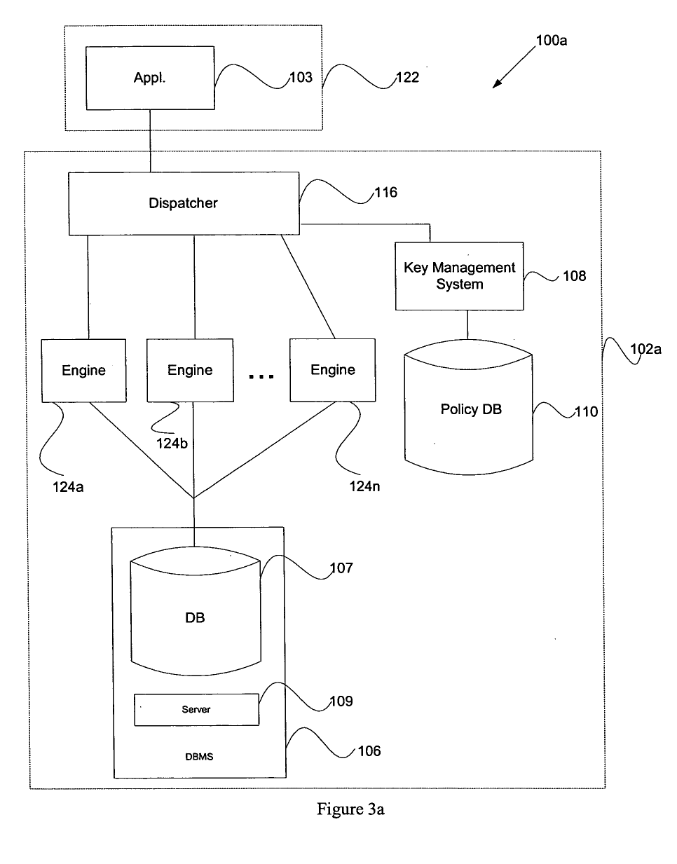

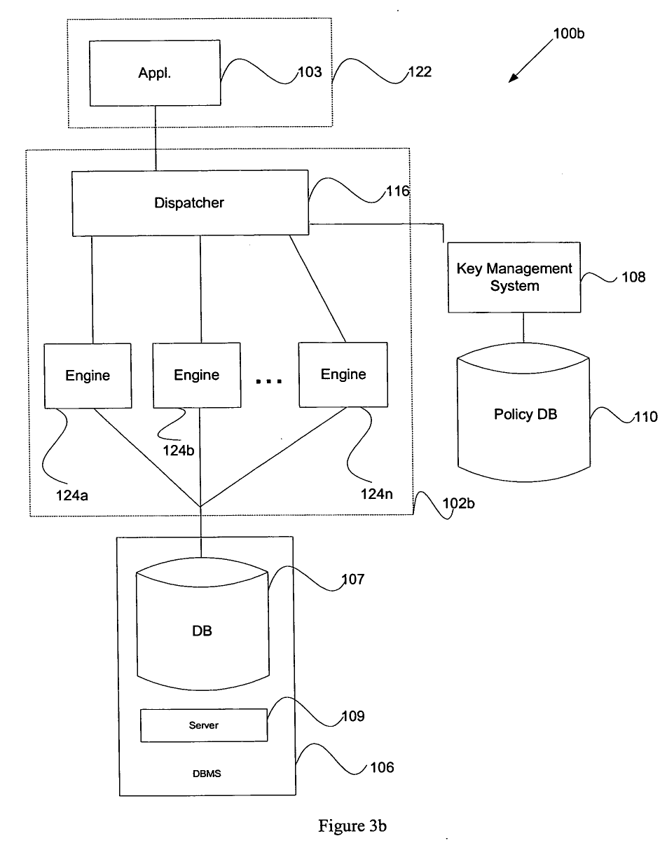

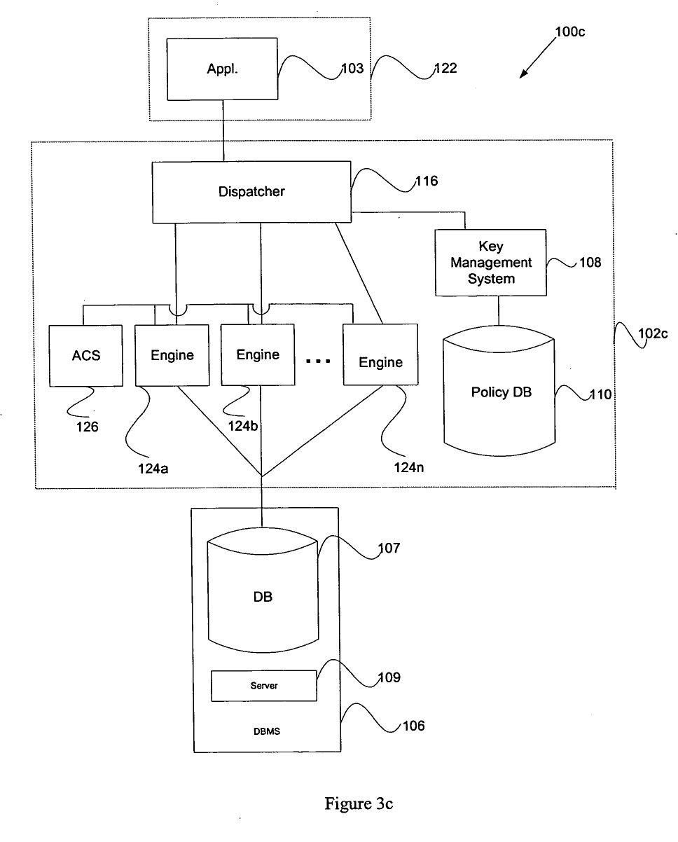

Referring now to FIG. 3a, a database system 100a comprising a client 122 and a server platform 102a is shown. As will be appreciated by those of skill in the art, the system 100a utilizes similar components and principles to the system 20 described above. Accordingly, like reference numerals preceded by the numeral “1” are used to indicate like elements whenever possible. The primary difference of the system 100a in comparison to system 20 is the replacement of pre-processors 12, 14 with one or more engines 124 and the schematic positioning of the dispatcher 116 within the server platform 102a.

The server platform 102a also includes a dispatcher 116, a key management system 108, one or more policy databases 110, one or engines 124 and one or more databases 107. The one or more databases may be communicatively coupled with a database management system (DBMS) 106 including a database server module 109 (e.g., a Secure.Data™ and/or a DEFIANCE™ DPS, available from Protegrity Corp. of Stamford, Conn.). In some embodiments, the server platform 102a contains a file system, network attached storage devices (NAS), storage area networks (SAN) or other storage device instead of a DBMS 106. The server platform 102a may also contain a combination of multiple storage devices such as a DBMS 106 and a file system, network attached storage devices (NAS), storage area networks (SAN) or other storage device. In addition to devices such as storage devices described herein, the engines 124 may be in communication with one or more applications that clients may utilize. The applications may reside on the client 122, another client 122, and/or server 102a platform.

The engines 124 may be any hardware and/or software device or combination of hardware and/or software including clients 122 or servers as described herein. The engines 124 may also be hardware devices. The engines 124 may exist as “virtual” engines 124, such that more than one engine exists on a single piece of hardware such as a server. In some embodiments such “virtual” engines 124 exist as separate threads within a process. The concept of threads and multi-threading is well known and thus not further described herein. In another embodiment, engines 124 existing on a single piece of hardware with multiple processors are each assigned to a separate processor.

One or more of the engines 124 may include tamper-proof hardware devices including, but not limited to devices described in U.S. Pat. No. 6,963,980 to Mattsson and Federal Information Processing Standards (FIPS) Publication 140-2. The entire contents of each of these documents is hereby incorporated by reference herein. For example, tamper-proof hardware could be a multi-chip embedded module, packages as a PCI-card. Additional implementations could include a general-purpose computing environment such as CPU executing software stored in ROM and/or FLASH.

One or more of the engines 124 may include or entirely consist of one or more cryptographic modules by the National Institute for Standards and Technology (NIST) Cryptographic Module Validation Program (CMVP). A current list of validated modules is available at http://csrc.nist.gov/cryptval/. Engines 124 may also implement systems and methods of de-encryption as described in U.S. patent application Ser. No. 11/357,351.

In some embodiments, the dispatcher 116 and/or engines 124 are configured such that an engine 124n may be added to the server platform 102a and become operational with minimal, if any, manual configuration. Such a system is similar to plug-and-play technologies in which a computer system automatically establishes the proper configuration for a peripheral or expansion card which is connected to it.

The components of FIG. 3a are connected as shown via communication channels, whether wired or wireless, as is now known or later developed. The communications channels may include a distributed computing network including one or more of the following: LAN, WAN, Internet, intranet, TCP\IP, UDP, Virtual Private Network, Ethernet, Gigabit Ethernet and the like.

The connections between the components in FIG. 3a are meant to be exemplary and not to be limiting. For example, in some embodiments of the inventions herein, an engine 124 may communicate directly with the key management system 8 to obtain the appropriate encryption key(s) for a query or request. In other embodiments, the engine 124 may communicate directly with the client application 103 to return the result of a query or request.

The dispatcher 116 receives queries from the client application 103 running on the client 124 as well as from other sources such as applications running on a servers as described herein. The dispatcher 116 can support secure socket layer (SSL) with strong authentication to enable an SSL channel between client 122 and dispatcher 116. The certificate used for authentication can be matched to the database the client application 103 accessed, to provide strong authentication. As described herein, the dispatcher 116 communicates with the key management system 108 to determine which actions (e.g., reads or writes to specific tables, columns and/or rows of the database 107) an individual user of client application 103 is permitted to carry out.

Transmission of encryption keys to the dispatcher 116 and/or the one or more engines 124 may be encrypted with a server key. Such encryption of encryption keys provides additional security to prevent encryption keys from being compromised.

The dispatcher 116 also communicates with the key management system 8 to determine the encryption status of any data elements of the database. Varying encryption standards and techniques exist that are appropriate for data of varying sensitivities. For example, the Federal Information Processing Standards (FIPS) developed by NIST define varying levels of encryption security. These standards have evolved as encryption technology has evolved. Pertinent FIPS publications include FIPS Publications 140, 140-1, 140-2, the contents of which are hereby incorporated herein. FIPS 140-2 defines four increasing encryption levels. FIPS 140-2 is used as an exemplary embodiment to explain various aspects of inventions herein. The inventions herein are applicable to encryption standards of all varieties.

Key Classes may be created to capture various encryption levels such as the FIPS 140-2 security levels. Service Classes denote the encryption capabilities of engines 124. Key Classes and Service Classes may be implemented as alphanumeric categories such as Key Class 1 or Key Class A. Such an implementation allows for easy comparison to determine if an engine 124 has an appropriate Service Class to perform cryptographic operations on a certain Key Class. In an embodiment where higher class numbers represented stronger encryption standards, an engine 124 would be capable of perform cryptographic operations on data of a Key Class if the Service Class number of the engine 124 is greater than or equal to the Key Class number.

Using granular encryption methods as described in WIPO Publication No. WO 97/49211, published on Dec. 24, 1997, the contents of which is hereby incorporated by reference herein, it is possible to encrypt different columns, rows and cells with varying levels of security. For example, in a customer information database, the credit card number field might be encrypted with Security Level 4 encryption while the address fields is encrypted with Security Level 2 encryption.

FIPS 140-2 defines standards for each security level. Embodiments of the invention herein allow for the implementation of varying FIPS 140-2 Security Levels while leveraging engines 124 that meet varying security level standards. For example, if security level criteria were changed such that an engine 124 that once qualified for Security Level 4 would henceforth only qualify for Security Level 3, the engine 124 could still be used for lower security levels.

As an example, an engine 124 of a Service Class conforming to FIPS Security Level 2 is required to have evidence of tampering (e.g., a cover, enclosure or seal on the physical aspects of the engine 124) as well as an opaque tamper-evidence coating on the engine's 124 encryption chip. In comparison, an engine 124 of a Service Class conforming to FIPS Security Level 3 is required to perform automatic zeroization (i.e. erasure of sensitive information such as encryption keys) when a maintenance access interface is accessed, as well as a removal-resistant and penetration-resistant enclosure for the encryption chip.

Service Classes could also be based on performance capabilities of engines 124. For example, cryptographic operations on various Key Classes may require certain attributes such as hardware encryption devices, processors, memory and the like.

In one embodiment, the dispatcher 116 may only assign queries of a particular Key Class to a designated engine 124. For example, a server platform 2 may include four engines 124 of varying security levels. Each engine 124 could be designated to handle queries or subqueries of a particular security level. For example, an engine 124 certified for Security Level 4 would be designated to handle queries and subqueries of Security Level 4 even though that engine 124 is capable of processing queries for Security Level 1, Security Level 2 and Security Level 3. Similarly, other engines 124 would be designated to handle queries and subqueries for Security Level 1, Security Level 2 and Security Level 3. It is further possible to augment the above implementation by adding additional engines 124 and utilizing one or more routing algorithms described herein. Alternatively, the dispatcher 116 may delegate queries and subqueries to any engine 124 capable of servicing the query.

The dispatcher 116 may use one or more load balancing algorithms to delegate queries and subqueries in a manner that promotes the efficient use of system resources such as engines 124. These algorithms include, but are not limited to: shortest queue, round robin, least processor usage, least memory usage, query hashing, source IP address, Round Trip Time (RTT), and geographic proximity. In applying the algorithms herein, the dispatcher 116 may be configured to detect the status of an engine 124 and suspend delegation to that engine 124 if the engine is off line (e.g. for maintenance) or if the link between the engine 124 and the dispatcher 116 is interrupted.

In a shortest queue algorithm, each engine 124 maintains a queue of query requests. A queue is a first-in first-out (FIFO) data structure. The dispatcher 116 may learn of the length of the queue in many ways as is well known. For example, the dispatcher 116 may poll the engines 124 periodically to request the length of each engine's queue. Alternatively, each engine 124 may communicate the length of said engine's queue at a predefined time interval, whenever the length of the queue changes, or at some combination of both. The length of the queue may be communicated through any method of electronic communications.

The dispatcher 116 may maintain a data structure containing the length of one or more engines' 124 queues or the dispatcher 116 may gather the lengths each time a query is received. In a “pure” implementation of a shortest queue algorithm, the dispatcher 116 will delegate the query to the engine with the shortest queue. However, other embodiments will delegate the query to the engine 124 with the shortest queue among the subset of engines 124 capable of the appropriate Service Class servicing the query's Key Class.

A shortest queue algorithm may be enhanced by weighting the length of each engine's 124 queue. For example, a SELECT query involving a heavily encrypted field may be weighted to count more heavily in calculating the queue length than an INSERT query because the SELECT query may require the engine 124 to iterate through the entire database and perform multiple de-encryptions. As another example, queue length might be discounted to reflect an engine's processor capacity. Thus, even if two engines 124 have identical queues, the engine 124 with a dual processor may be perceived to have a shorter queue than the engine 124 with a single processor because of the disparity in processing power.

A round robin algorithm may be implemented to delegate queries to engines 124. In a round robin algorithm, the dispatcher 116 delegates queries to engines 124 in a predictable order, generally without regard to the conditions of the engines 124. Simplicity is the round robin algorithm's main advantage. The dispatcher 116 needs to know minimal, if any, information about the engines 124. In some embodiments, the dispatcher will delegate the query to the engine 124 designated by the round robin algorithm only if the engine is of a Service Class capable of servicing the query's Key Class. If the engine 124 is not capable of servicing the Key Class, the engine 124 may be bypassed and query delegated to the next engine 124 according to the round robin algorithm.

The round robin algorithm can be enhanced to improve overall performance. In further enhancements, the dispatcher 116 may maintain certain performance information regarding one or more of the engines 124. This information may include, but is not limited to, the average wait time for a query to be serviced and/or queue length. When delegating queries to engines 124 according to the round robin, the dispatcher 116 may not delegate a query to an engine 124 with an average wait time or a queue length above a defined threshold level, in order to relieve some of the burden from the engine 124.

In least processor usage and least memory usage algorithms, a dispatcher 116 learns of the processor and/or memory usage of one or more engines 124. This information may be gathered from the engines 124 in a variety of ways as described in the shortest queue algorithm herein. When a query is received by the dispatcher 116, the query may be delegated according to these algorithms to the engine 124 with the lowest processor usage and/or memory usage. As in the other load balancing algorithms described herein, the encryption capabilities of one or more engines 124 may be analyzed to ensure that the query is forwarded to an engine 124 capable of performing encryption/de-encryption for the Key Class.

In a query hashing or source IP address hashing algorithm, a query or IP address is processed by a hash in order to delegate the query to an engine 124. A hash function is a function h: U→{0,1,2, . . . , N−1}, wherein U is an input (in this case a query string or IP address) and N is the number of engines 124. The hash function computes an integer for every query string or IP address U. In an efficient hash function, h will produce a distribution that approximates a discrete uniform distribution, i.e. the probability of an unknown query string U being assigned to an engine 124 is the same for each engine 124. Hash functions are well known and are described further in Giles Brassard and Paul Bratley, Fundamentals of Algorithms 160-61 (1996), the contents of which are hereby incorporated herein by reference.

A variety of geographic proximity algorithms maybe implemented, preferably in combination with other algorithms herein. The dispatcher 116 stores a table of distances between the dispatcher 116 and each engine 124. This table may be updated as additional information is known. The distance may be in geographic terms, such as feet, meters, or miles, or it may be expressed in network terms, such as the number of “hops” (i.e. nodes that must be traversed) for a query to reach the engine 124 or in Round Trip Time (RTT). Numerous algorithms of this variety are well known to one of ordinary skills in the art including Bellman-Ford and Ford-Fulkerson. Such algorithms, as well as other applicable algorithms from the field of computer networks, are described in Andrew S. Tanenbaum, Computer Networks 343-95 (4th ed. 2003), the contents of which is hereby incorporated by reference herein.

Referring now to FIG. 3b, the server platform 102b may encapsulate only the dispatcher 116 and the engines 124. The key management system 108 and the policy database 110 can be separate resources that are not integrated with the server platform 102b. Such an implementation may be advantageous because the server platform can be easily integrated between the application 103 and the DBMS 106, minimizing any changes required by the end user. Moreover, the key management system 108 and policy database 110 may be managed separately allowing for a more flexible deployment and operation.

In any implementation, particularly an implementation according to FIG. 3b, a router or switch may exist to coordinate communication between the engines 124 and the DBMSs 106. In implementations according to FIG. 3b, the router may be included in the server platform 102b to allow for a server-platform that requires a minimal number of communication links.

Referring now to FIG. 3c, a database system 100c comprising a client 122 and a server platform 102c is shown. As will be appreciated by those of skill in the art, the system 100c utilizes similar components and principles to the system 100b described above. The differences between systems 100b and 100c are related to the addition of an access control system 126 in communication with one or more engines 124. The access control system 126 may be any system or apparatus capable of producing an intrusion detection profile. The access control system 126 may be implemented in many ways including, but not limited to, embodied in a server, a client, a database or as a freestanding network component (e.g., as a hardware device). In some embodiments, the access control system 126 is part of the Secure.Data™ server or the DEFIANCE™ suite, both available from Protegrity Corp. of Stamford, Conn. The access control system 126 distributes item access rules and/or intrusion detection profiles (which contain item access rules) to the engines 124. The engines 124 detect violations of item access rules and/or intrusion detection profiles in combination with or independently from encryption/de-encryption functions. The access control system 126 continually monitors user activity, and prevents a user from accessing data that the user is not cleared for. This process is described in detail in U.S. Pat. No. 6,321,201, filed Feb. 23, 1998.

An intrusion detection profile distributed to engines 124 by the access control system 126 may exist in many forms including, but not limited to, plain text, mathematical equations and algorithms. The profile may contain one or more item access rules. Each item access rule may permit and/or restrict access to one or more resources. A rule may apply generally to all users, or the rule may apply to specific users, groups, roles, locations, machines, processes, threads and/or applications. For example, system administrators may be able to access particular directories and run certain applications that general users cannot. Similarly, some employees may be completely prohibited from accessing one or more servers or may have access to certain servers, but not certain directories or files.

Furthermore, rules may vary depending on the date and time of a request. For example, a backup utility application may be granted access to a server from 1:00 AM until 2:00 AM on Sundays to perform a backup, but may be restricted from accessing the server otherwise. Similarly, an employee may have data access privileges only during normal business hours.

Additionally, the rules need not simply grant or deny access, the rules may also limit access rates. For example, an employee may be granted access to no more than 60 files per hour without manager authorization. Such limitations may also be applied at more granular levels. For example, an employee may have unlimited access to a server, but be limited to accessing ten confidential files per hour.

Rules may also grant, prohibit and/or limit item access for a particular type of network traffic. Item access rules may discriminate between various types of network traffic using a variety of parameters as is known to one of ordinary skill in the art including, but not limited to, whether the traffic is TCP or UDP, the ISO/OSI layer of the traffic, the contents of the message and the source of the message.

These types of item access rules may be implemented in isolation or in combination. For example, an employee in a payroll department might be granted increased access to timesheet files on Mondays in order to review paychecks before releasing information to the company's bank. This same employee might have less access from Tuesday through Sunday.

In some embodiments, data intrusion profiles may be fashioned by an entity such as the access control system 126 or an administrator to reflect usage patterns. For example, an employee, who during the course of a previous year never accesses a server after 7:00 PM, may be prohibited from accessing the database at 8:15 PM as this may be indicative of an intrusion either by the employee or another person who has gained access to the employee's login information.

The server platform 2, 102a, 102b, 102c in any Figure included herein may be implemented as a single piece of hardware or may include several pieces of hardware or software. The server platform may implemented in a highly portable and self contained data center, such as Project Blackbox, available from Sun Microsystems, Inc. of Santa Clara, Calif., to enable end users to easily utilize the inventions herein without requiring a build out of the end user's existing data center.

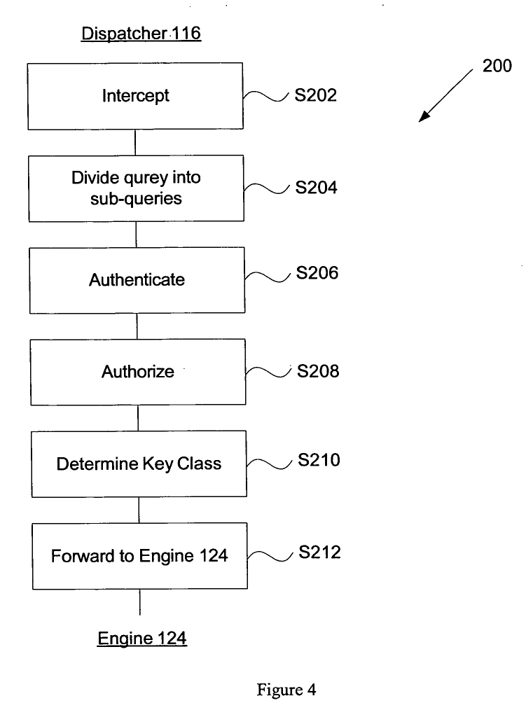

Referring now to FIG. 4, there is illustrated a flow chart 200 depicting a process of servicing requests to an encrypted database. In step S202, the dispatcher 116 intercepts a query. In some embodiments, a request or command is intercepted. For example, the command may direct the engine to make an entry in a log file regarding an event. In some embodiments of the inventions herein, the query may be divided into sub-queries that relate to different portions of the database (step S204). These portions can include selected rows, selected columns, or combinations thereof. These different portions of the database 107 typically have different levels of security and/or encryption.

For example, the following query may be divided into at least two subqueries for faster processing:
SELECT CustomerID, Address, City, State, ZIP, CreditCardNumber
FROM customers2005
UNION
SELECT CustomerID, Address, City, State, ZIP, CreditCardNumber
FROM customers2006
   The SELECT query from customers2005 and the SELECT query from customers2006 could each constitute a subquery. The UNION query could also constitute a subquery. Moreover, each subquery could be further divided into subqueries by separating queries for different fields. For example, the subquery
SELECT CustomerID, Address, City, State, ZIP, CreditCardNumber
FROM customers2005
   could be divided into the following subqueries:
SELECT CustomerID, Address, City, State, ZIP
FROM customers2005
and
SELECT CustomerID, CreditCardNumber
FROM customers2005
   While this approach may require additional processing such as a JOIN after each subquery is executed, the net processing time may still be faster than if the undivided query is processed by only one engine 124. This performance benefit may be particularly salient when dealing with a strongly encrypted field containing information such as credit card numbers.

Still referring to FIG. 4, in step S206, the query is authenticated, i.e. the dispatcher 116 assesses whether the query actually came from the user or application 103 that is purported to have sent the query. Authentication can be accomplished by examining one or more credentials from the following categories: something the user/application is (e.g., fingerprint or retinal pattern, DNA sequence, signature recognition, other biometric identifiers, or Media Access Control (MAC) address), something the user/application has (e.g., ID card, security token, or software token), and something the user/application knows (e.g., password, pass phrase, or personal identification number (PIN)).

Once the query is authenticated, the dispatcher 116 determines whether the user or application 103 is authorized to execute the query (step 208), typically by communicating with the key management system 108. Next, or while checking for authorization in step 208, the dispatcher 116 obtains the key class for each encryption data element (step 210).

In step S212, the dispatcher 116 forwards (delegates) one or more queries or subqueries to one or more engines 124. The queries or subqueries may be delegated according to one or more load balancing algorithms. The actual communication between dispatcher 16 and engines 124 may occur through any method or including, but not limited to, plain text, UDP, TCP/IP, JINI and CORBA, all of which are well known and thus not further described herein.

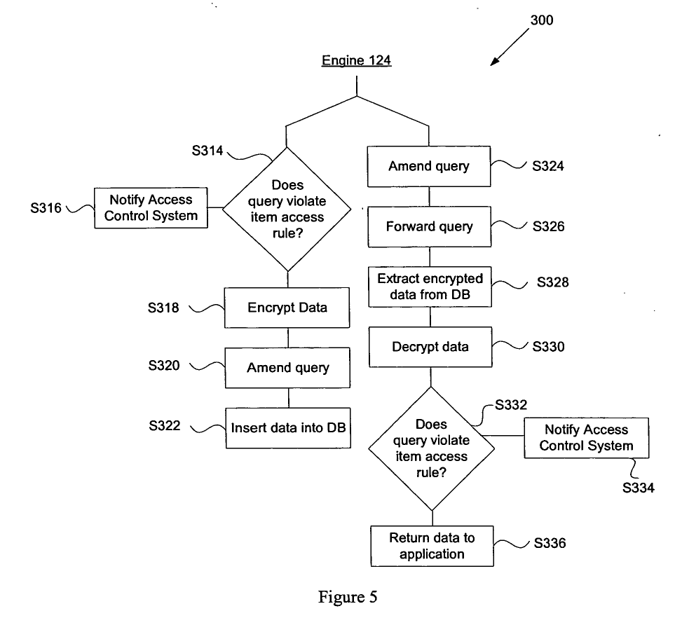

Referring now to FIG. 5, a flowchart 300 is shown depicting a process of servicing request to an encrypted database. The flowchart 300 depicts a continuation of the process illustration in FIG. 4, continuing from the step S212 when the query or subquery is delegated to an engine 124. For example, if the query is sent to engine 124a, the engine 124a will process queries based on the type of query or sub-query. Steps S314-S322 depict the method of processing an INSERT query. UPDATE, MERGE (UPSERT) and DELETE queries are executed in an analogous process to INSERT. Steps S324-S334 depict the method of processing request query such as SELECT, including JOIN and UNION.

In the case of an INSERT operation, the query is analyzed to determine if the sub-query violates an item access rule (e.g., by altering data that the user is not allowed to modify) (step S314). If the query does violate an item access rule, the access control system 126 is notified. If the query does not violate an item access rule, the engine 124a encrypts the data to be inserted (step S318), amends the query to replace the data with the encrypted data (step S320), and then forwards the query to the DBMS 106 for insertion (step S322).

In the case of a request operation, the dispatcher 16 amends the query (step S324), and forwards the amended query to the database 107 (step S326). The requested information is extracted from the database 107 (step S328), returned to the engine 124a and de-encrypted (step S330) by the engine 124a. The requested information is analyzed to determine if the query violated an item access rule (e.g., retrieving transaction information from a time period that the user is not authorized to view) (step S332). If an item access rule is violated, the access control system 126 is notified (step S334). Additionally or alternatively, an alarm system may be notified so that appropriate personnel may be alerted of a potential security breach. If an item access rule is not violated, the engine 124a sends the decrypted result to the client application 103 (step S336). A more detailed explanation of the above process is provided herein with regard to FIGS. 2a and 2b.

In some embodiments, steps S332 and S334 may be additionally or alternatively performed earlier in the process for a request query. For example, steps S332 and S334 may occur before S324, between steps S324 and S326, and/or between steps S328 and S330. Performing steps 332 and S334 earlier may provide performance improvements, especially where certain queries (e.g., SELECT ALL CreditCardNumber, CreditCardExpDate FROM CUSTOMERS) can be identified as violations of an item access rule before data is retrieved.

As a result, data in transit is protected by encryption, yet the database 107 is not overloaded because encryption responsibilities have been delegated to engines 124. Moreover, the data encryption process is now easily scalable through additional engines 124. Maintenance of engines 124 may also be scheduled for normal business hours by taking one engine 124 offline while the remaining engines 124 service encryption requests.

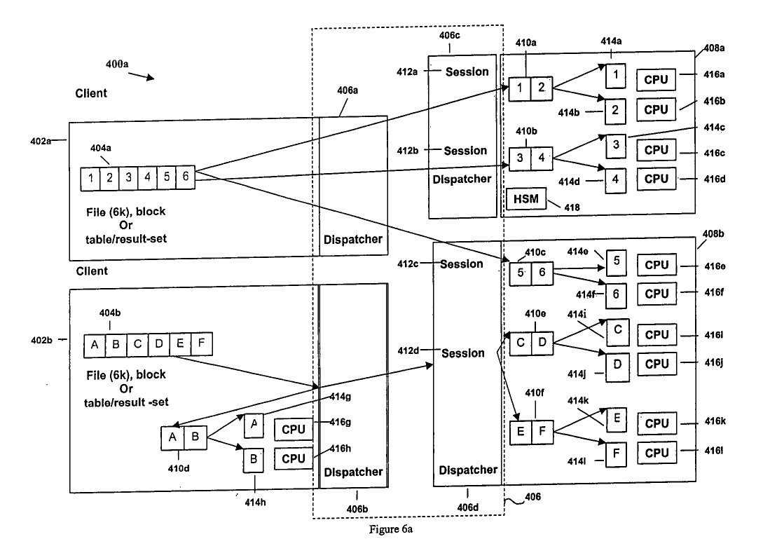

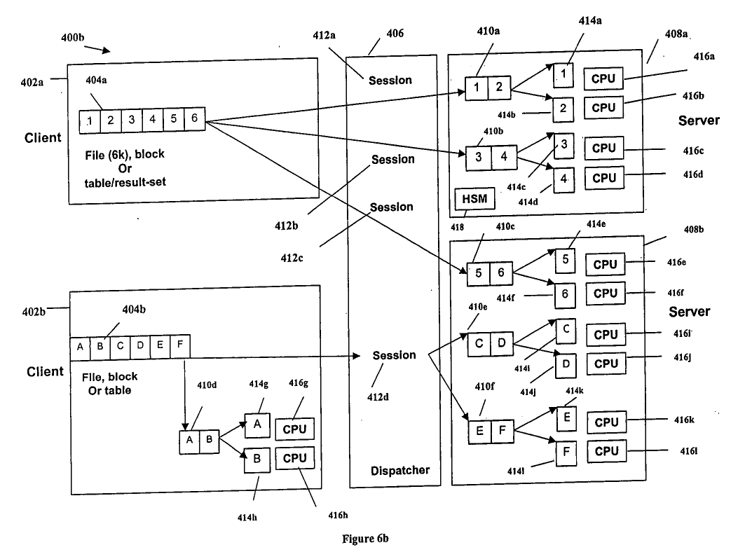

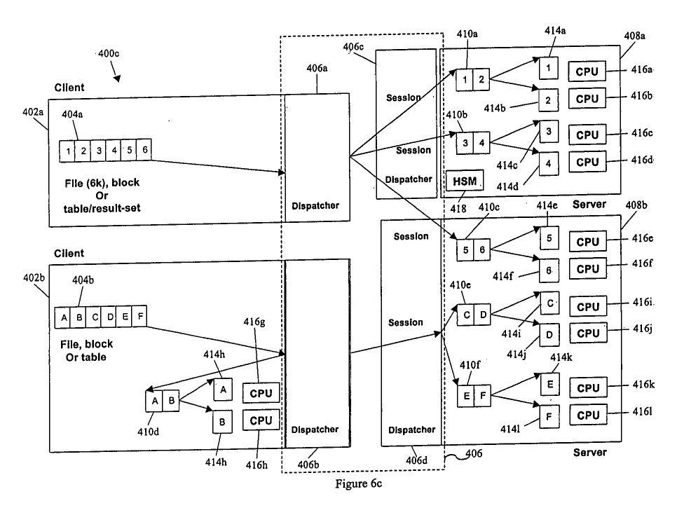

Referring now to FIG. 6a, two clients 402a, 402b exist, each with data 404a, 404b, respectively, to be encrypted. The clients may be the same or similar to client 22 in system 20 and/or client 122 in systems 100a, 100b, and 100c. The data 404a, 404b may be, for example, a file, a block, or a component of a database such as a table, row, column, element or result-set.

The clients 402a, 402b send a request, including the data 404a, 404b, to one or more dispatchers 406. The dispatcher may be the same or similar to dispatcher 116 in systems 100a, 100b, and 100c. The one or more dispatcher 406 can be a single dispatcher, implemented on a server, personal computer or standalone hardware device. The dispatcher 406 may also be a distributed system with one or more processes or hardware components implemented on one or more of the clients 402a, 402b.

The dispatcher 406 delegates the requests according to one or more of the load balancing algorithms described herein. The dispatcher 406 may have multiple components 406a, 406b, 406c, 406d. Components of the dispatcher 406a, 406b may reside on the clients 402a, 402b, while other components 406c, 406d may reside on an engine 408a, 408b. The engine may be the same or similar to preprocessors 12 and 14 in systems 20 and 30, and/or engines 124a-n in systems 100a, 100b, and 100c. One or more individual components 406a, 406b, 406c, 406d may be implemented as separate dispatchers 406.

FIG. 6a shows two of several possible encryption load balancing scenarios. In the one scenario, the client 402a contains data 404a to be encrypted/de-encrypted. The data 404a are capable of being divided into several pieces (in this scenario, at least six). The client 402a sends three requests 410a, 410b, 410c to the dispatcher 406 requesting encryption/de-encryption of the data 404a. The decision to make three requests (as opposed to one or some other integer) may be made by the client 402a or by the dispatcher 406 or a component of the dispatcher 406a and may be made in accordance with one or more of the load balancing algorithms described herein. In particular, requests 410a and/or 410b may have been sent to engine 408a because engine 408a contains a hardware security module (HSM) 418, which may provide a needed encryption level and/or performance capability.

Each request 410a, 410b, 410c is handled by a session 412a, 412b, 412c on the dispatcher 406. The dispatcher 406 or engine 408a, 408b separates the requests 410a, 410b, 410c into several sub-requests 414a-f and delegates each of these sub-requests 414a-f according to load balancing algorithms as described herein. In this scenario, each sub-request 414a-f is delegated to separate CPUs 416a-f. In other embodiments, multiple sub-requests 414 may be delegated to one or more CPUs 416. Moreover, in some embodiment, each CPU 416 may be treated as an engine 408 for load balancing purposes.

In another scenario, the client 402b sends a single request for encryption-de-encryption of data 404b to the dispatcher 406. The request is handled by a session 412d on the dispatcher 406. The dispatcher 406 divides the request into three sub-requests 410d, 410e, 410f. One sub-request is 410d is delegated to the client 410d, where the sub-request 410d is further divided into two sub-requests 414g, 414h to be handled by two CPUs 416g, 416h. The remaining two sub-requests 410e, 410f are handled in manner similar to the other scenario described above.

Referring now to FIG. 6b, the dispatcher 406 may be implemented independently from the clients 402a, 402b and/or the engines 408a, 408b. Additionally, the client 402b may delegate a request or sub-request 410d to itself without sending the request or sub-request 410d to the dispatcher 406.

Referring now to FIG. 6c, a dispatcher 406b may exist in, on, or in connection with a client 402b. The dispatcher 406b is aware of encryption capabilities of the client 402b and may dispatch portions of a request 410d to the client 402b for cryptographic operations. By dispatching part of the request 410d locally, performance may be improved because a portion of the request 410d will not need to travel over the network to an engine 408.

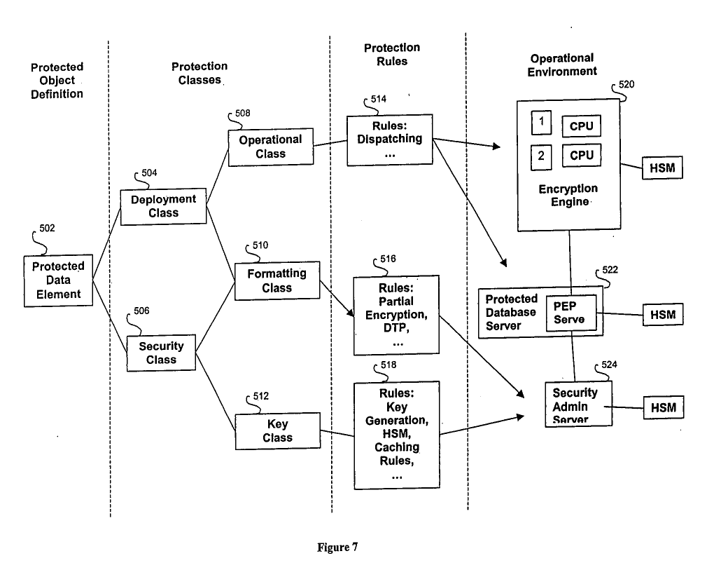

Referring now to FIG. 7, a schematic overview of how the attributes of a protected data element 502 affect cryptographic operations is depicted. The data element 502 has a deployment class 504 and security class 506. The deployment class 504 is a representation of an operational class 508 and a formatting class 510. The security class 506 is a representation of the formatting class 510 and a key class 512. The deployment class 504, security class 506, operational class 508, formatting class 510, and key class 512 are protection classes that are abstractions of data protection schemes, e.g. rules.

The operational classes are associated with protection rules that affect how the data is handled in the operational environment. The operation class 508 is associated with rules 514 that, for example, determine how encryption requests for the data element 502 are dispatched to engines and/or clients. The formatting class 510 is associated with rules 516 that determine how data is stored and displayed to users and applications. Various formatting and storage techniques are described in provisional U.S. patent application Ser. No. 60/848,251, filed Sep. 29, 2006, the contents of which are hereby incorporated by reference herein. The key class 512 is associated with rules 518 that determine, how often keys are generated and rotated, whether keys may be cached, etc. The operational rules primarily affect one or more engines 520 and database servers 522, while the formatting rules 516 and key rules 518 primarily affect one or more security administration servers 524.

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, computers, clients, servers and the like) shown as distinct for purposes of illustration may be incorporated within other functional elements, separated in different hardware or distributed in a particular implementation.

In particular, elements from separate embodiments herein may be combined. For example, a dispatcher 116 may receive requests and delegate the requests to a front-end preprocessor 14 and a second preprocessor 12. As another example, one or more engines 124 may be substituted for a front-end preprocessor 14 and/or a back-end preprocessor 12 in system 20.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

What is claimed is:

1. An encryption load balancing and distributed policy enforcement system comprising:
one or more engines for communicating with one or more devices and for executing cryptographic operations on data; and
a dispatcher, in communication with the one or more engines, that receives one or more requests from a client and delegates at least one of the one or more requests to the one or more engines.

2. The system of claim 1, wherein the data is contained in or produced in response to the one or more requests.

3. The system of claim 1, wherein a first of the engines has a different service class than a second of the engines.

4. The encryption load balancing system of claim 1, wherein the device is a database and the requests are queries.

5. The system of claim 4, wherein the dispatcher is configured to parse at least one of said one or more queries and delegate at least one of said one or more queries to a subset of said one or more engines on the basis of query type.

6. The system of claim 1, wherein the dispatcher is configured to delegate at least one of said one or more queries to the client.

7. The system of claim 1, wherein the client is configured to delegate at least one of said one or more queries to the client.

8. The system of claim 1, wherein the addition of an additional engine requires minimal manual configuration.

9. The system of claim 1, wherein the dispatcher is configured to delegate at least one of said one or more queries to at least one of said one or more engines using a load balancing algorithm.

10. The system of claim 9, wherein the load balancing algorithm is a shortest queue algorithm wherein a length of at least one of the one or more engines' queue is weighted.

11. The system of claim 10, wherein the queue is weighted to reflect complexity of at least one of the one or more requests delegated to the engine.

12. The system of claim 11, wherein the queue is weighted to reflect the engine's processing power.

13. The system of claim 1, wherein the dispatcher is in further communication with a key management system to obtain one or more encryption keys related to the one or more queries.

14. The system of claim 13, wherein the one or more encryption keys communicated by the dispatcher to the one or more engines are encrypted with a server encryption key.

15. The system of claim 1, wherein at least one of the one or more engines analyzes whether one of the requests violates an item access rule.

16. The system of claim 15, wherein the system further comprises an access control manager for distributing one or more access rules to at least one of the one or more engines.

17. The system of claim 16, wherein at least one of the one or more engines reports an item access rule violation to the access control manager.

18. The system of claim 17, wherein the access control manager analyzes the violation and adjusts at least one item access rule for a user or a group.

19. An encryption load balancing system comprising:
(a) one or more devices;
(b) a client having an application for generating one or more requests for data residing on the devices;
(c) a key management system, in communication with a policy database;
(d) one or more engines, in communication with the one or more devices, for executing cryptographic operations on data contained in or produced in response to the one or more requests; and
(e) a dispatcher, in communication with the client, the key management system, and the one or more engines, that
(i) receives the requests from the client;
(ii) communicates with the key management system to verify the authenticity and authorization of the requests; and
(iii) delegates the requests to the one or more engines using a load balancing algorithm.

20. An encryption load balancing method comprising:
receiving a request for information residing on a device from a client; and
delegating the request to one or more engines configured to execute cryptographic operations on data.

21. The method of claim 20, the method further comprising dividing the request into one or more sub-request.

22. The method of claim 21, wherein the method further comprising delegating at least one of the sub-requests to the client.

23. The method of claim 20 wherein the request is delegated using a load balancing algorithm.

24. The method of claim 20, the method further comprising communicating with a key management system to determine whether a request is authorized.

25. The method of claim 20, the method further comprising communicating with a key management system to determine the key class of a request.

26. The method of claim 20, wherein the request is a sub-request.

27. The method of claim 20, wherein the request is an insertion command.

28. The method of claim 20, the method further comprising:
generating encrypted data from the data in the request;
amending the request to replace the data with the encrypted data; and
forwarding the request to the device.

29. The method of claim 28, the method further comprising determining whether the request constitutes a violation of at least one item access rule.

30. The method of claim 29, the method further comprising notifying an access control system of the violation.

31. The method of claim 20, the method further comprising:
forwarding the request to the device;
receiving encrypted data from the device;
decrypting the encrypted data; and
returning unencrypted data to a client.

32. The method of claim 31, the method further comprising
determining whether the result of the request constitutes a violation of at least one item access rule.

33. The method of claim 32, the method further comprising:
notifying the access control system of the violation.

34. An encryption load balancing method comprising:
(a) receiving a request for information residing on a device from a client;
(b) verifying authorization of the request and determining a key class of the request by communicating with a key management system; and
(c) delegating, through use of a load balancing algorithm, the request to one or more engines configured to execute cryptographic operations on data, wherein the engine:
(i) generates encrypted data from the data in the request;
(ii) amends the request to replace the data with the encrypted data; and
(iii) forwards the request to the device.

35. An encryption load balancing method comprising:
(a) receiving a request for information residing on a device from a client;
(b) verifying authorization of the request and determining a key class of the request by communicating with a key management system; and
(c) delegating, through use of a load balancing algorithm, the request to one or more engines configured to execute cryptographic operations on data, wherein the engine:
(i) forwards the request to the device;
(ii) receives encrypted data from the device;
(iii) decrypts the encrypted data; and
(iv) returns unencrypted data to the client.

36. A computer-readable medium whose contents cause a computer to perform an encryption load balancing method comprising:
receiving a request for information residing on a device from a client; and
delegating the request to one or more engines configured to execute cryptographic operations on data.

37. An encryption load balancing system comprising:
a first preprocessor for communicating with one or more devices and for receiving requests from a client;
a second preprocessor for executing cryptographic operations on data contained in and produced in response to the requests; and
a dispatcher arranged to divide a request into at least a first and a second sub-request, and to delegate the first sub-request to the first preprocessor and the second sub-request to the second preprocessor.

38. The system of claim 37, wherein the sub-requests are delegated to the preprocessors using a load balancing algorithm.

39. An encryption load balancing system comprising:
(a) one or more storage devices having:
(i) a first portion encrypted at a first encryption level; and
(ii) a second portion encrypted at a second encryption level that differs from the first encryption level;
(b) a first preprocessor configured to receive a request for information residing on one or more of the storage devices from a client application, the request:
(i) seeking interaction with first data from the first portion; and
(ii) seeking interaction with second data from the second portion;
(c) a second preprocessor in communication with the first preprocessor, the second preprocessor configured to execute a cryptographic operations on data contained in or produced in response to the request; and
(d) a dispatcher in communication with the first preprocessor, the dispatcher being configured:
(i) to separate a database request into a first sub-request for interaction with the first data and a second sub-request for interaction with the second data;
(ii) to delegate the first sub-request to the first preprocessor; and
(iiI) to delegate the second sub-request to the second preprocessor.

40. The system of claim 39, wherein the dispatcher delegates a plurality of sub-requests to a plurality of second preprocessors using a load balancing algorithm.
